(19) United States
(12) Patent Application Publication
(10) Pub. No.: US 2006/0112931 A1
(43) Pub. Date: Jun. 1, 2006

(54) Accelerator pedal device

(75) Inventor: Haruo Meguro, Miyagi (JP)

Correspondence Address: BIRCH STEWART KOLASCH & BIRCH, PO BOX 747, FALLS CHURCH, VA, 22040-0747, US

(73) Assignee: Keihin Corporation

(21) Appl. No.: 11/263,829

(22) Filed: Nov. 2, 2005

(30) Foreign Application Priority Data
Sep. 9, 2004 (JP) 2004-262483

(51) Int. Cl. F02D 11/10

(52) U.S. Cl. 123/399

(57) ABSTRACT

An accelerator pedal device is fixed through a housing to a body. By stepping on an accelerator pedal arm supported pivotally by the housing, the accelerator pedal arm and a interlocking member rotationally move integrally, and a spring set between an arm part of the interlocking member and a detection part provided for the housing elongates and contracts. Therefore, the pedaling amount of the accelerator pedal arm is applied as press force through the spring to the detection part, and the press force is output as an electric signal from the detection part through a controller to a drive part. Hereby, opening of a throttle valve is controlled.

### BACKGROUND OF THE INVENTION

1. Field of the Invention

The present invention relates to a cable-less accelerator pedal device adaptable to a vehicle, and more particularly to an accelerator pedal device including a detecting unit detecting a pedaling amount of an accelerator pedal.

2. Description of the Background Art

In a vehicle such as an automobile, conventionally, in place of an accelerator pedal device using an accelerator cable that connects a throttle valve for controlling the volume of intake air inspired in an internal combustion engine and an accelerator cable, a cable-less accelerator pedal device has been adopted, which electrically detects the pedaling amount of the accelerator pedal and controls an opening amount of the throttle valve.

In this accelerator pedal device, a rotation angle sensor is provided on a rotation shaft that functions as a supporting point of the rotational operation of the accelerator pedal, the pedaling amount of the accelerator pedal detected by the rotation angle sensor is converted into an electric signal, thereafter the electric signal is transmitted through a control part to a drive source, and the drive source controls an opening amount of the throttle valve whereby the volume of the intake air inspired in the internal combustion engine is controlled.

In this case, in such the accelerator pedal device, a return spring member for returning the accelerator pedal to a full closing position thereof is provided. When a driver lowers pedaling force onto the accelerator pedal, the accelerator pedal is returned by elastic force of the return spring member to the full closing position that is an initial position of the accelerator pedal (refer to, for example, Japanese Patent Unexamined Publication JP-A-11-343882).

On the other hand, in the accelerator pedal device that controls the opening amount of the throttle valve by the conventional accelerator cable, when the driver depresses on the accelerator pedal against the elastic force of a return spring provided on the throttle valve, reaction force is produced, and sliding resistance by the accelerator cable is generated when the driver pedals on-and-off the accelerator pedal. In the cable-less accelerator pedal device, the return spring member is provided in place of the return spring provided on the throttle valve, whereby the reaction force when the driver pedals on the accelerator pedal is produced. However, the sliding resistance by the accelerator cable is not generated when the driver pedal the accelerator pedal on-and-off.

As a result, when the driver changes a vehicle from a vehicle adopting the conventional accelerator pedal device to a vehicle adopting the cable-less accelerator pedal device, the driver feels differences in operation of the accelerator pedal. Therefore, the cable-less accelerator pedal device adopts a hysteresis generation mechanism that causes intendedly resistant feeling resemblant to the sliding resistance by the accelerator cable (refer to, for example, Japanese Patent Unexamined Publication JP-A-2002-283872)

In the JP-A-11-343882, it is necessary to provide the rotation angle sensor for detecting the pedaling amount of the accelerator pedal (that is, the rotation amount thereof) so as to be coaxial with the rotation shaft that supports the accelerator pedal. Therefore, there is a problem that the dimension in the width direction that is nearly orthogonal to an axis of the accelerator pedal in the accelerator pedal device increases, which makes the size of the accelerator pedal device large. Specifically, the width dimension near the rotation shaft in the accelerator pedal device increases.

Further, the rotation angle sensor is provided, for example, between the accelerator pedal that is a rotary part in the accelerator pedal device and a body that is a fixed part. Therefore, there is required adjustment works such as position-matching with the accelerator pedal and the body. Therefore, there is a problem that the attachment work of the rotation angle sensor becomes complicated, which causes the increase of the manufacturing steps of the accelerator pedal device. Particularly, in case that a Hall element type sensor is adopted as the rotation angle sensor, when a magnetic (for example, permanent magnet) provided for the accelerator pedal is detected by the Hall element, there is a problem that detection accuracy lowers because of position-mismatching between the magnetic and the Hall element that is a detection part and unsteadiness in the radial direction that is nearly orthogonal to the rotary direction.

Further, since the rotation angle sensor converts the pedaling amount of the accelerator pedal into the rotation angle (rotation amount), it must have rotation stroke according to the rotation amount of the accelerator pedal. Therefore, there is fear that in the accelerator pedal having large rotation amount, the rotation angle sensor will be made large correspondingly, and the structure of the rotation angle sensor will be complicated.

### SUMMARY OF THE INVENTION

The invention has been made in view of the above various problems. One of objects of the invention is to provide an accelerator pedal device that simplifies its constitution thereby to perform size-reduction, and can secure easiness of its manufacture.

In order to achieve the object, according to a first aspect of the present invention, there is provided an accelerator pedal device comprising:

a body;

an accelerator pedal rotatably supported on the body, and applied pedaling force from a driver;
an elastic member provided so as to elongate and contract according to a rotation of the accelerator pedal in order to convert a rotational displacement of the accelerator pedal into press force of the elastic member;

a detection part provided on the body detecting pressure value of the press force; and

a throttle valve control unit controlling an opening amount of a throttle valve in accordance with only the detected pressure value.

According to the invention, the elastic member that elongates and contracts in the rotational direction of the accelerator pedal is provided. Therefore, when the pedaling force of the driver applies to the accelerator pedal and rotates the accelerator pedal, the elastic member elongates or contracts by the rotation of the accelerator pedal and the press force is applied from the elastic member to the detection part, whereby the pressure value of the press force is detected. That is, the rotation of the accelerator pedal transmits to the elastic member so as to convert the rotation displacement of the accelerator pedal into the press force by the elastic displacement of the elastic member, and thereafter, the converted press force is transmitted to the detection part.

Therefore, compared the present invention with the case where the rotation amount of the accelerator pedal is detected by the conventional rotation angle sensor, since the press force corresponding to the pedaling amount of the accelerator pedal is applied to the detection part by the elastic member, the value on the basis of the pedaling amount can be detected with high accuracy by the detection part. Further, the constitution of the detection part in the present invention can be simplified compared with the conventional rotation angle sensor. Therefore, since the size of the accelerator pedal device can be reduced, and the detection part can be readily assembled to the body, assembly workability can be improved.

Further, according to a second aspect of the present invention, as set forth in the first aspect of the present invention, it is preferable that the accelerator pedal comprises:

a pedal arm provided with a pedal portion, to which the pedaling force is applied, on a first end side;

an interlocking member engaged with a second end side of the pedal arm and rotating integrally with the pedal arm; and

a hysteresis generating mechanism comprising:

a first engagement part formed on the pedal arm; and

a second engagement part formed on the interlocking member so as to oppose to the first engagement part and engage with the first engagement part,

wherein the elastic member is engaged with either the pedal arm or the interlocking member, and

when the pedal arm rotates, the hysteresis generating mechanism divides a rotation force of the pedal arm into rotation force of the interlocking member and axial force in an axial direction substantially orthogonal to a rotation direction of the interlocking member.

That is, when the driver pedals on the pedal arm, a movement of the interlocking member is divided into a rotational movement which integrally moves with the pedal arm and an linear movement which separating the pedal arm from the interlocking member by the elastic member. The linear movement is caused by sliding both of the first engagement part formed at either the pedal arm or the interlocking member and the second engagement part that is opposed to the first engagement part while contacting each other due to the elastic force of the elastic member. Hereby, the pedal arm and/or the interlocking member moves in the direction where they separate from each other and comes into contact with the body, and the pedal arm and/or the interlocking member moves rotationally in a contacting state with the body. Thus, the rotational force of the pedal arm is divided into the rotational force and the axial force thereof.

Therefore, when the driver controls the pedaling force applying on the pedal arm, hysteresis can be generated by the hysteresis generating mechanism and the elastic member similarly to the conventional accelerator pedal device in which the accelerator pedal and the throttle valve are connected by the accelerator wire.

Further, according to a third aspect of the present invention, it is preferable that the elastic member comprises a compression coil spring comprising:

a first end portion engaged with the end portion of the interlocking member; and

a second end portion engaged with a detection part side of the body.

Thus, since the both ends of the compression coil spring are engaged respectively with the interlocking member and the detection part, the constitution of the engagement member with the elastic member can be simplified. Therefore, the size of the device can be reduced, and the device can be manufactured at a low cost.

Furthermore, according to a fourth aspect of the present invention, it is preferable that the detection part comprises a pressure sensor being capable of converting the pressure value of the press force into an electric signal,

the pressure sensor is attached to an attachment hole formed on the body, and

a wiring connected to the pressure sensor and a connection terminal part connected to the wiring are formed integrally with the body.

Thus, by adopting the pressure sensor functioning as the detection part, it is possible to convert the press force applied by the accelerator pedal into the electric signal appropriately to control the throttle vale. Further, since the pressure sensor can be readily attached into the attachment hole of the body, the detection part can be manufactured separately from the accelerator pedal. Therefore, after the accelerator pedal has been assembled to the body, the detection part previously unitized may be set.

Further, since the wiring connected to the pressure sensor and the connection terminal connected to the wiring are formed integrally with the body, simply by only attaching the pressure sensor into the attachment hole, the pressure sensor can be connected to the wiring and the connection terminal. Therefore, the complicated works such as position-matching of the pressure sensor with the body and connection of the pressure sensor to the wiring become unnecessary so that assembly workability of the accelerator pedal device can be improved.

In addition, according to a fifth aspect of the present invention, it is preferable that the elastic member is arranged on substantially central part of the accelerator pedal in a width direction thereof, the width direction being substantially orthogonal to a rotational direction of the accelerator pedal.

Hereby, when the accelerator pedal moves rotationally relative to the body, a point of application of load of the accelerator pedal is set to be the center of the elastic member, so that any moment is not produced in the elastic member. Further, since the elastic member is arranged in the nearly central part in the width direction of the accelerator pedal, compared with the case where the rotation angle sensor is provided coaxially with the rotation shaft in the conventional accelerator pedal, the dimension in the width direction of the body can be reduced. Therefore, rigidity of the body can be heightened, and rigidity of the accelerator pedal device can be improved. Further, without increasing the dimension in the width direction of the accelerator pedal device, the size of the accelerator pedal device can be reduced, so that the degree of freedom in layout can be increased.

According to a sixth aspect of the present invention, it is preferable that the elastic member biases the accelerator pedal so as to return the accelerator pedal in an initial position where the pedaling force is not applied.

According to a seventh aspect of the present invention, it is preferable that the first engagement part comprises a slant surface which is slant relative to a plane orthogonal to a rotational axis of the accelerator pedal,

the second engagement part comprising a slant surface which is slant relative to the plane orthogonal to the rotational axis of the accelerator pedal, and

the first engagement part contacts with the second engagement part on the respective slant surfaces.

According to an eighth aspect of the present invention, it is preferable that at least one of protrusions is formed on either the first engagement part or the second engagement part, the protrusion comprising:

a slant surface which is slant relative to a plane orthogonal to a rotational axis of the accelerator pedal; and

an orthogonal surface which is orthogonal to the plane orthogonal to the rotational axis of the accelerator pedal;

wherein the slant surface and the orthogonal surface are arranged around the rotational axis of the accelerator pedal, and

at least one of grooves is formed on either the second engagement part or the first engagement part, of which shape corresponds to a shape of the protrusion so as to engage with the protrusion.

According to a ninth aspect of the present invention, it is preferable that a friction surface is formed on either the pedal arm or the interlocking member,

a swollen portion is formed on the body so as to oppose to the friction surface, and

when the accelerator pedal does not rotate, a predetermined clearance is defined between the friction surface and the swollen portion and

when the accelerator pedal rotates the friction surface slides against the swollen portion while the friction surface contacting with the swollen portion.

According to a tenth aspect of the present invention, it is preferable that the elastic member is arranged on a side opposite to a side, in which the pedal portion is arranged, relative to a rotational axis of the accelerator pedal.

According to an eleventh aspect of the present invention, it is preferable that the elastic member applies reaction force against the pedaling force of the driver.

According to a twelfth aspect of the present invention, it is preferable that the elastic member is arranged so that a longitudinal axis of the elastic member is twisted relative to a rotational axis of the accelerator pedal, and

the elastic member elongates and contracts in the longitudinal axis thereof.

According to a thirteenth aspect of the present invention, it is preferable that there is provided a vehicle comprising the accelerator pedal device as set forth in the first aspect of the present invention.

According to a fourteenth aspect of the present invention, as set forth in the second aspect of the present invention, it is preferable that the pedaling force drives the hysteresis generating mechanism to generate the frictional resistance.

It is preferable that the throttle valve control unit controls the opening amount of the throttle valve in accordance with only the detected pressure value.

According to the invention, the following advantage can be obtained.

The accelerator pedal is moved rotationally by the pedaling force of the driver, whereby the rotational displacement of the accelerator pedal is converted by the elastic member into the press force in the axial direction, and the press force that represents the pressure value corresponding to the pedaling amount of the accelerator pedal can be detected by the detection part. Therefore, compared with the case where the rotation amount of the accelerator pedal is detected by the conventional rotation angle sensor, the pedaling amount of the accelerator pedal can be detected as the pressure value by the detection part with high accuracy, and the constitution of the detection part can be simplified. Therefore, the size of the accelerator pedal device can be reduced, and the assembly workability can be improved.

### BRIEF DESCRIPTION OF THE DRAWINGS

FIG. 1 is a front partially sectional view of an accelerator pedal device according to an embodiment of the invention;

FIG. 2 is a side partially sectional view of the accelerator pedal device in FIG. 1;

FIG. 3 is an exploded perspective view of an accelerator pedal arm and an interlocking member in FIG. 2;

FIG. 4 is a side partially sectional view showing a state where an accelerator is full opening by pedaling on a pedal portion toward the body side in the accelerator pedal device in FIG. 2; and

FIG. 5 is a schematic block diagram showing a signal transmission system till the pedaling amount of the accelerator pedal arm detected by the accelerator pedal device in FIG. 1 is transmitted as a detection signal to a throttle valve.

### DETAILED DESCRIPTION OF THE PREFERRED EMBODIMENTS

A preferred embodiment of the accelerator pedal device according to the invention will be described below in detail with reference to attached drawings.

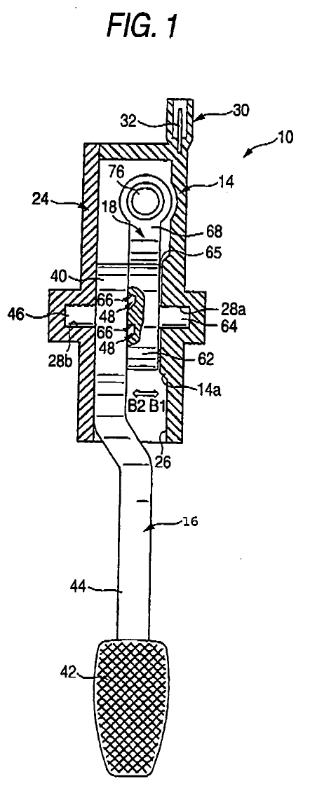

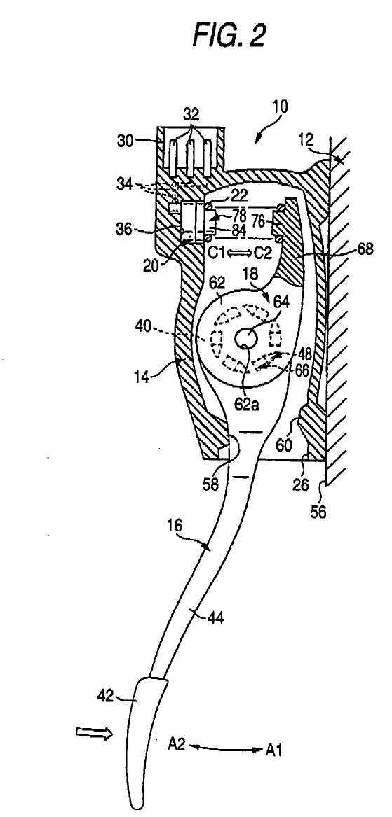

In FIGS. 1 and 2, reference numeral 10 represents an accelerator pedal device according to an embodiment of the invention.

This accelerator pedal device 10 comprises a housing (body) 14 fixed to a vehicular body 12 (refer to FIG. 2) in a vehicle such as an automobile, an accelerator pedal arm (pedal arm) 16 supported pivotally for the housing 14, a interlocking member 18 provided in the housing 14, and rotating integrally with the accelerator pedal arm 16 under rotational action of the accelerator pedal arm 16, a detection part 20 for detecting the rotation amount of the accelerator pedal arm 16, and a spring (elastic member) 22 set between the detection part 20 and the interlocking member 18.

The housing 14 is, for example, formed of a resin material, and to one side surface thereof, a cover member 24 (refer to FIG. 1) is attached. The housing 14, by attachment of the cover member 24, is in hollow shape having an opening portion 26 that opens on one side, and is fixed to the vehicular body 12 so that the opening portion 26 is located downward as shown in FIG. 2. Further, as shown in FIG. 1, on an inner wall surface in the nearly central portion of this housing 14, a pin hole 28a is formed and also in the cover member 24, a pin hole 28b is formed similarly in the position opposed to the pin hole 28a.

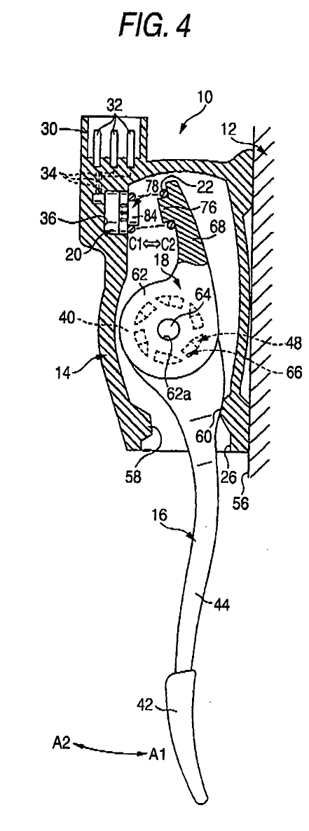

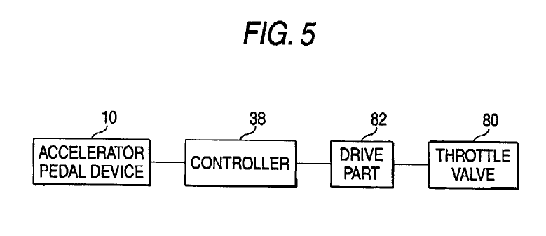

Further, at the upper portion of the housing 14, as shown in FIGS. 2 and 4, a connector connection part 30 that is connected to a controller 38 (refer to FIG. 5) described later is integrally formed, and plural terminals 32 provided in the connection part 30 are respectively connected to the detection part 20 through lead wires 34. The connection part 30 and the terminal 32 function as a connection terminal part.

Further, near the connection part 30 in the housing 14, an attachment hole having the predetermined depth 36 is formed in the inner wall surface of the housing 14, and the detection part 20 is provided in the attachment hole 36. In the connection part 30, the connector and the lead wire 34 connected to the connector may be molded integrally with the housing 14.

This detection part 20 has a pressure sensor that can convert the pressure applied to the detection part 20 from the outside into an electric signal, and a pressure value detected by the pressure sensor is output as a detection signal from the connection part 30 to the controller 38 (refer to FIG. 5) provided on the outside thereof. As this pressure sensor, for example, a strain gauge may be adopted. In this case, the strain gauge is stuck to a load converter, whereby the detected pressure value is output to the controller 38. Alternatively, by a piezoelectric element, the pressure value may be detected.

The accelerator pedal arm 16 is integrally formed of, for example, a resin material, and has a first rotor part 40 that is formed on one end side thereof and has the nearly circular shape, a pedal part 42 that is formed on the other end side thereof and receives pedaling force from a driver (not shown) of a vehicle, and a coupling arm 44 that connects the first rotor part 40 and the pedal part 42.

The first rotor part 40, as shown in FIG. 1, is provided so that one side surface thereof comes close to the inner wall surface of the cover member 24, and a first support shaft 46 is formed in the nearly central portion of the first rotor part 40 so as to protrude to the inner wall surface of the cover member 24. The first support shaft 46′ of the first rotor part 40 is inserted into the pin hole 28b of the cover member 24, whereby the accelerator pedal arm 16 is held by the cover member 24 rotatably. Further, the invention is not limited to the case where the first support shaft 46 is inserted into the pin hole 28b of the cover member 24. For example, a convex part (not shown) protruding from the inner wall surface of the cover member 24 to the first rotor part 40 is provided, and the convex part is inserted into a hole portion (not shown) formed in the first rotor part 40, whereby the accelerator pedal arm 16 may be held rotatably.

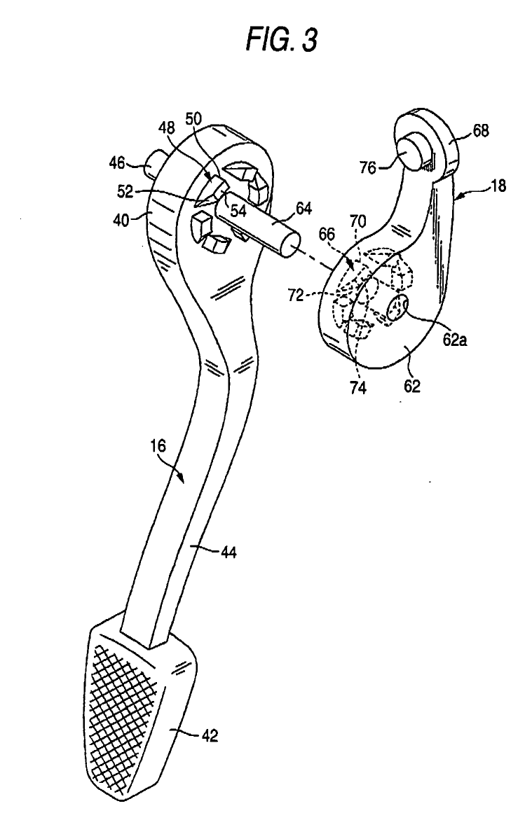

Further, on the other side surface of the first rotorpart 40, as shown in FIG. 3, a second support shaft 64 is formed coaxially with the first support shaft 46 so as to protrude. This second support shaft 64 is formed so that its length becomes larger than the length of the first support shaft 46.

Further, on the other side surface of the first rotor part 40, as shown in FIG. 3, plural tooth parts (first engaging part) 48 are formed annularly around the second support shaft 64. These plural (for example, six) tooth parts 48 are protrusively formed so as to be spaced away from each other in the circumferential direction of the other side surface of the first rotor part 40.

Specifically, the shape of the single tooth part 48 is formed by an orthogonal surface 50 formed so as to be nearly orthogonal to the other side surface of the first rotor part 40, a slant surface 52 formed so as to slant to the other side surface of the first rotor part 40 at the predetermined angle, and a peripheral surface 54 that connects the end portion of the orthogonal surface 50 and the end portion of the slant surface 52, and is formed nearly in parallel to the other side surface. This slant surface 52 is formed in the same direction along the circumferential direction of the first rotor part 40, for example, formed so as to slant to the other side surface of the first rotor part 40 at an angle of 45°.

The coupling arm 44, as shown in FIGS. 2 and 4, extends downward of the peripheral surface 54 of the first rotor part 40 so as to become narrower, and extends downward while curving slightly in the direction (direction of an arrow A2 in FIG. 2) separating from an attachment surface 56 of the vehicular body 12 in a state where it is locked by a first stopper 58 of the housing 14. Further, as shown in FIG. 1, the coupling arm 44 extends to the first rotor part 40 side from the pedal part 42 by the predetermined length, thereafter bends toward the cover member 24 side, and extends in the shape of a straight line that is nearly parallel to the inner wall surface of the cover member 24.

As shown in FIGS. 2 and 4, on the inner wall surface of the housing 14, the first stopper 58 and a second stopper 60 are formed in positions where the coupling arm 44 comes into contact with the inner wall surface when the accelerator pedal arm 16 moves rotationally with the first support shaft 46 and the second support shaft 64 as a supporting point. The first stopper 58 is formed at the portion with which the coupling arm 44 comes into contact in an accelerator full closing state where the not-shown driver does not pedal on the accelerator pedal arm 16 (refer to FIG. 2), while the second stopper 60 is formed at the portion with which the coupling arm 44 comes into contact in an accelerator full opening state where the driver steps on the accelerator pedal arm 16 (refer to FIG. 4). Further, the first stopper 58 and the second stopper 60 respectively protrude from the inner wall surface of the housing 14 slightly, and are formed so as to be opposed to each other.

The pedal part 42, as shown in FIG. 1, is formed with larger width than the width of the coupling arm 44, and provided at the lower end portion of the accelerator pedal arm 16. In this case, the invention is not limited to the case where the accelerator pedal arm 16 is formed of a resin material. For example, only the coupling arm 44 may be formed of a metal material, and the first rotor part 40 and the pedal part 42 may be formed of the resin material.

The interlocking member 18 is provided in the housing 14, and comprises a second rotor part 62 engaged with the first rotor part 40 of the accelerator pedal arm 16, and an arm part 68 extending upward of the circumferential surface of the first rotor part 40.

The second rotor part 62 is provided so that one side surface thereof comes close to a swollen portion 14a formed on the inner wall surface of the housing 14, and a through-hole 62a piercing from one side surface to the other side surface is formed in the second rotor part 62 (refer to FIG. 3). Into the through-hole 62a of the second rotor part 62, the second support shaft 64 of the accelerator pedal arm 16 is inserted. The second support shaft 64 is inserted into the pin hole 28a formed in the swollen portion 14a of the housing 14, whereby the interlocking member 18 enters a state where it is held rotatably by the housing 14.

Here, the invention is not limited to the case where the second support shaft 64 is inserted into the pin hole 28a of the housing 14. For example, a convex part (not shown) protruding from the swollen portion 14a of the housing 14 to the second rotor part 62 is provided, and the convex part is inserted into the through-hole 62a, whereby the interlocking member 18 may be held rotatably. In this case, between one side surface of the second rotor part 62 and the inner wall surface of the housing 14, a clearance 65 (refer to FIG. 1) having the predetermined space is formed.

On the other hand, on the other side surface of the second rotor part 62, plural (for example, six) engagement grooves (second engaging part) 66 each having pedaling of the predetermined depth are formed annularly around the through-hole 62a. These plural engagement grooves 66 are formed so as to be spaced in the circumferential direction of the other side surface of the second rotor part 62. Each of these engagement grooves 66 is formed in the position opposed to the tooth part 48 of the accelerator pedal arm 16. Namely, the engagement grooves 66 formed in the second rotor part 62 are formed so that the number of them becomes the same as that of the tooth parts 48 formed at the first rotor part 40.

Specifically, the shape of the single engagement groove 66 is, as shown in FIG. 3, similarly to the tooth part 48, formed by an orthogonal surface 70 formed so as to be nearly orthogonal to the other side surface of the second rotor part 62, a slant surface 72 that slants to the other side surface of at the predetermined angle and caves in, and an inner surface 74 that connects the end portion of the orthogonal surface 70 and the end portion of the slant surface 72, and is formed nearly in parallel to the other side surface. This slant surface 72 is formed so as to slant to the other side surface of the second rotor part 62 at an angle of 45°.

Into each engagement groove 66 of the second rotor part 62, each tooth part 48 of the first rotor part 40 is inserted thereby to engage with the engagement groove 66. In this case, the side surface of the first rotor part 40 and the side surface of the second rotor part 62 come into contact with each other, and the tooth part 48 engages with the engagement groove 66 so that the slant surfaces 52 and 72 of the tooth part 48 and the engagement groove 66 are opposed to each other and come into contact with each other, and the orthogonal surfaces 50 and 70 are opposed to each other and come into contact with each other. The plural tooth parts 48 and engagement grooves 66, as described later, function as a hysteresis mechanism.

In this case, the invention is not limited to the case where the tooth part 48 is formed at the first rotor part 40 and the engagement groove 66 is formed in the second rotor part 62. For example, the tooth part 48 may be formed at the second rotor part 62 and the engagement groove 66 may be formed in the first rotor part 40 thereby to engage the first rotor part 40 and the second rotor part 62, or the tooth parts 48 may be formed respectively at the first rotor part 40 and the second rotor part 62 thereby to engage the tooth parts 48 with each other.

Hereby, when the accelerator pedal arm 16 moves rotationally with the first support shaft 46 as a support point, the interlocking member 18 engaging with the accelerator pedal arm 16 integrally moves rotationally with the second support shaft 64 as a support point. In this time, the accelerator pedal arm 16 and the interlocking member 18, as shown in FIG. 1, are assembled so that the arm part 68 of the interlocking member 18 and the coupling arm 44 of the accelerator pedal arm 16 are aligned.

In the embodiment, as shown in FIG. 1, the first rotor part 40 of the accelerator pedal arm 16 is arranged on the cover member 24 side that is the left side, and the second rotor part 62 of the interlocking member 18 is arranged on the housing 14 side that is the right side. However, the invention is not limited to this. On the contrary, the interlocking member 18 may be provided on the cover member 24 side, and the accelerator pedal arm 16 may be provided on the housing 14 side. Further, the first rotor part 40 may be divided into two. In this case, the second rotor part 62 of the interlocking member 18 is engaged between the divided rotor portions.

On the other hand, at the arm part 68, as shown in FIGS. 2 and 4, a spring guide 76 is formed in the position opposed to the detection part 20 provided for the housing 14. Between the spring guide 76 protruding to the detection part 20 and a guide member 78 attached into the attachment hole 36 of the housing 14 together with the detection part 20, a spring 22 is set. This spring 22 is composed of, for example, a compression coil spring, and its elastic force biases the interlocking member 18 having the arm part 68 in the direction (direction shown of an arrow C2) where the interlocking member 18 is separated from the guide member 78.

Further, instead of that the spring 22 is provided between the arm part 68 of the interlocking member 18 and the guide member 78 as described above, the spring 22 may be provided between the inner wall surface of the housing 14 on which the second stopper 60 is formed and the coupling arm 44 in the accelerator pedal arm 16, and the detection part 20 may be provided on the inner wall surface of the housing 14 opposed to the spring 22.

The guide member 78 is provided in this attachment hole 36 so that its one end surface comes into contact with the detection part 20, and on the other end surface thereof, the spring 22 is provide for a protrusion part 84 protruding to the interlocking member 18 side. Namely, the spring 22 is engaged by the spring guide 76 of the interlocking member 18 and the protrusion part 84 of the guide member 78, whereby the displacement of the spring in the radial direction is regulated. Therefore, even when the spring 22 elongates and contracts, it never drops out.

Thus, the detection part 20 is in a held state between the inner wall surface of the attachment hole 36 and the guide member 78. Therefore, when the accelerator pedal arm 16 and the interlocking member 18 integrally moves rotationally, and the spring 22 elongates and contracts through the arm part 68, the press force is applied from the spring 22 through the guide member 78 to the detection part 20.

The accelerator pedal device 10 according to the embodiment of the invention is basically constructed as described above. Next, an operation and a working effect of the accelerator pedal device 10 will be described. In the following description, the accelerator full closing state in which the driver does not pedal on the pedal part 42 of the accelerator pedal arm 16 is taken as an initial state (refer to FIG. 2).

Firstly, when opening (accelerator opening) of a throttle valve 80 (refer to FIG. 5) is increased in order to accelerate a vehicle, a not-shown driver pedals on the pedal part 42 of the accelerator pedal arm 16 toward the attachment surface 56 side of the vehicular body 12. Hereby, the accelerator pedal arm 16 moves rotationally with the first and second support shafts 46 and 64 as the support point counterclockwise (in the direction shown of an arrow A1) in FIG. 2. With this rotational movement, through the second rotor part 62 engaged with the first rotor part 40 of the accelerator pedal arm 16, the interlocking member 18, similarly to the accelerator pedal arm 16, moves rotationally with the second support shaft 64 as the support point counterclockwise (in the direction of the arrow A1).

At this time, the second rotor part 62, by the spring 22 provided for the arm part 68, is always biased in the direction of the arrow C2. Therefore, the slant surface 72 of the engagement groove 66 in the second rotor part 62 slides through the elastic force of the spring 22 along the slant surface 52 of the tooth part 48 in the first rotor part 40. As a result, the second rotor part 62 moves along the axial direction of the second support shaft 64 in the direction separating from the first rotor part 40 (in the direction of an arrow B1 in FIG. 1) Namely, the rotation drive force of the first rotor part 40 is divided into the rotational force in the rotational direction and the axial force in the axial direction (directions of arrows B1 and B2) of the second support shaft 64.

Hereby, the side surface of the second rotor part 62 moves gradually in the axial direction (direction of the arrow B1) of the second support shaft 64 by the clearance 65. Lastly, the side surface of the second rotor part 62 comes into contact with the inner wall surface of the housing 14. Therefore, hereafter, the side surface of the second rotor part 62, while coming into contact with the inner wall surface of the housing 14, moves rotationally. Hereby, between the interlocking member 18 and the swollen portion 14a of the housing 14, sliding resistance (friction) is produced. Therefore, like the conventional accelerator pedal device in which the accelerator pedal and the throttle valve 80 are connected by the accelerator wire, the driver can pseudoly feel the sliding resistance of the accelerator wire in the pedal operating time. Note that the hysteresis generating mechanism is directly driven by the pedal force of the operator. In this case, so that the desired sliding resistance can be obtained between the housing 14 and the second rotor part 62, it is proper to set a material, surface treatment, surface roughness and contact area of the housing 14 and the second rotor part 62, and press load of the second rotor part 62 onto the housing 14.

Further, the sliding surface that causes the sliding resistance when the accelerator pedal arm 16 is rotationally moved is not limited to the case where it is composed of the side surface of the second rotor part 62 of the interlocking member 18 and the inner wall surface of the housing 14. The sliding surface may be composed of the side surface of the first rotor part 40 of the accelerator pedal arm 16 and the inner wall surface of the cover member 24. Further, the sliding surfaces may be provided for the first rotor part 40 and the second rotor part 62 respectively.

By the rotational movement of the interlocking member 18 in the direction of the arrow A1, the spring 22 is pressed toward the guide member 78 side (direction of an arrow C1) by the arm part 68 of the interlocking member 18, and the guide member 78 is pressed toward the detection part 20 side at the predetermined pressure by the press force. Hereby, the detection part 20 composed of the pressure sensor converts the press force from the guide member 78 into an electrical signal and detects the signal, and its detection signal is output through the lead wire 34 from the terminal 32 of the connection part 30 to the controller 38 (refer to FIG. 5). At this time, since the driver is stepping on the accelerator pedal arm 16 against the elastic force of the spring 22, he can feel the reaction force similar to the reaction force biased by the return spring provided for the throttle valve in the conventional accelerator pedal device.

Next, as shown in FIG. 5, the controller 38 performs the operation processing on the basis of the detection signal, and thereafter, a drive part 82 (for example, stepping motor) is rotation-driven by the output signal from the controller 38 by the predetermined amount. Hereby, opening of the throttle valve 80 coupled to a drive shaft (not shown) of the drive part 82 is controlled, and the volume of intake air inspired in a cylinder room of an engine through the throttle valve 80 is controlled.

Further, on the contrary, in case that the driver relaxes stepping on the pedal part 42 to reduce the opening of the throttle valve 80, he relaxes the pedaling force applied onto the accelerator pedal arm 16. Hereby, the arm part 68 of the interlocking member 18 is pressed by the elastic force of the spring 22 in the direction separating from the detection part 20 (in the direction of the arrow C2), and the accelerator pedal arm 16 and the interlocking member 18 move rotationally in the direction separating from the vehicular body 12 (in the direction of the arrow A2).

At this time, as the press force applied from the spring 22 through the guide member 78 to the detection part 20 becomes smaller, the pressure value detected by the detection part 20 becomes smaller. This pressure value is output as an electric signal through the connection part 30 to the controller 38, and thereafter transmitted to the drive part 82. Correspondingly to this pressure value, opening of the throttle valve 80 is controlled to become small under the drive action of the drive part 82. In result, the volume of intake air inspired in the cylinder room of the engine through the throttle valve 80 is controlled.

As described above, in the embodiment, the spring 22 is provided between the interlocking member 18 rotationally moving integrally with the accelerator pedal arm 16 and the detection part 20 provided for the housing 14, whereby the pedaling amount of the accelerator pedal arm 16 can be directly detected as the press force through the spring 22 by the detection part 20. Namely, compared with the case where the rotation amount of the accelerator pedal is detected by the conventional rotation angle sensor, the pedaling amount for the accelerator pedal arm 16 can be detected as the pressure value by the detection part 20 such as the pressure sensor at high accuracy, and assembly of the detection part 20 to the accelerator pedal device 10 can be also readily performed.

Further, since this spring 22 has the function of supplying the pressure value corresponding to the pedaling amount of the accelerator pedal arm 16 to the detection part 20, the pedaling amount can be surely and easily detected simultaneously with the driver's stepping operation.

Further, compared with the case where the rotation angle sensor is provided coaxially with the rotation shaft of the conventional accelerator pedal device, since the detection part 20 can be provided in the housing 14 of which the direction is the rotational direction of the accelerator pedal arm 16 and the interlocking member 18, the size in the width direction of the accelerator pedal device 10 can be reduced. Therefore, the degree of freedom in layout of the accelerator pedal arm 16 and the interlocking member 18 in the accelerator pedal device 10 can be increased.

Furthermore, since the size in the width direction of the housing 14 can be reduced, rigidity of the housing 14 can be heightened, so that rigidity of the accelerator pedal device 10 can be heightened as a whole.

Furthermore, the spring 22 has the function of increasing and decreasing the press force onto the detection part 2 according to the pedaling amount of the accelerator pedal arm 16, and further has, apart from its function, the function of generating reaction force (friction) when the not-shown driver steps on the accelerator pedal arm 16. Therefore, compared with the conventional accelerator pedal device, a feeling of physical disorder is not produced.

Further, the spring 22 has three functions: a function of a pressure converter that converts the rotation displacement of the interlocking member 18 into stroke displacement through the arm part 68 and transmits the stroke displacement as the press force to the detection part 20; a function of generating reaction force when the driver steps on the accelerator pedal arm 16; and a function of returning the accelerator pedal arm 16 to the initial position when the pedaling force onto the accelerator pedal arm 16 is relaxed. Therefore, the constitution of the accelerator pedal device 10 can be simplified, so that the size of the accelerator pedal device 10 can be reduced.

Further, since the detection part 20 can detect the press force on the basis of the expansion and contraction displacement of the spring 22 in the stroke direction, the detection part 20 does not require the movable portion that is necessary for the conventional rotation angle sensor, so that the size of the detection part 20 can be reduced.

Furthermore, as shown in FIG. 1, in the accelerator pedal device 10, the arm part 68 holing the spring 22 is arranged so as to be located between the first rotor part 40 and the second rotor part 62 orthogonally to the axial direction of the accelerator pedal arm 16. Hereby, the spring 22 is arranged in the nearly central portion in the width direction of the first and second rotor parts 40, 62. Therefore, when the accelerator pedal arm 16 moves rotationally in relation to the housing 14, a load working point of the arm part 68 becomes the center of the spring, so that the moment is not produced in the spring 22. Further, since the arrangement of the spring 22 does not causes the increase of size in the width direction of the accelerator pedal device 10, the size of the accelerator pedal device 10 can be reduced.

Furthermore, in the accelerator pedal device 10, the accelerator pedal arm 16 and the interlocking member 18 can be manufactured separately from the detection part 20 such as the pressure sensor attached to the attachment hole 36 of the housing 14. Therefore, the detection part 20 can be previously unitized solely and manufactured, and it can be readily attached to the attachment hole 36 of the housing 14. Further, after the accelerator pedal arm 16 and the interlocking member 18 have been arranged in the housing 14, the detection part 20 may be arranged in the housing 14.

Therefore, the unsteadiness of the rotation shaft produced in the rotation angle sensor of the conventional accelerator pedal device is removed, the relative positioning between the accelerator pedal arm 16 and the detection part 20 becomes unnecessary, and the assembly workability of the accelerator pedal device 10 can be improved. Namely, the detection part 20 is attached to the attachment hole 36 of the housing 14 so as to be connected to the lead wire 34 connected to the terminal 32 of the connection part 30, whereby the complicated position-matching work of the rotation angle sensor that has been performed in the conventional accelerator pedal device is not required.

Further, compared with the rotation angle sensor that has been adopted in the conventional accelerator pedal device, since the detection part 20 such as the pressure sensor has no movable portion, the detection part 20 has an advantage that it is superior in durability. On the other hand, also compared with the non-contact type rotation angle sensor that uses the Hall element, since the detection part 20 has no movable portion, the detection part 20 has an advantage that it is superior in accuracy and durability.

More specifically, the non-contact type rotation angle sensor that uses the Hall element requires, as a detection device, a detected part (movable portion) on the side of a magnetic (for example, permanent magnet), and a detection part (fixed portion) on the Hall element side including the Hall element. Therefore, the non-contact type rotation angle sensor has a complication that exact position-matching between the detected part and the detection part is required. However, for the detection part 20 in the accelerator pedal device 10 according to the invention, it is not necessary to provide the detected part such as the movable magnetic, and the complicated work of position-matching between the detected part and the detection part is not necessary.

In the afore-described embodiment, the engagement parts of the hysteresis generating mechanism are formed on a side surfaces, which are orthogonal to the rotational axis of the accelerator pedal, of the pedal arm and the interlocking member, respectively, however, the present invention is not limited thereto. For example, the engagement part of the pedal arm side may be formed on a surface, which is parallel to the rotational axis of the acceleration pedal, so far as to divide the rotational force of the pedal arm into the rotational force of the interlocking member and the axial direction force of the interlocking member.

Further, in the embodiment, the elastic member is disposed on a side opposite to a side in which the pedal portion is arranged, relative to the rotational axis of the accelerator pedal, however, the elastic member may be disposed on the side in which the pedal portion is arranged, relative to the rotational axis of the accelerator pedal.

Note that in the above-described embodiment, the pressure sensor is provided on a side of the vehicle body near to a driver, the present invention is not limited. The pressure sensor may be provided on a side of the vehicle far from the driver.

While there has been described in connection with the preferred embodiments of the present invention, it will be obvious to those skilled in the art that various changes and modification may be made therein without departing from the present invention, and it is aimed, therefore, to cover in the appended claim all such changes and modifications as fall within the true spirit and scope of the present invention.

What is claimed is:

1. An accelerator pedal device comprising:
a body;
an accelerator pedal rotatably supported on the body, and applied pedaling force from a driver;
an elastic member provided so as to elongate and contract according to a rotation of the accelerator pedal in order to convert a rotational displacement of the accelerator pedal into press force of the elastic member;
a detection part provided on the body detecting pressure value of the press force; and
a throttle valve control unit controlling an opening amount of a throttle valve in accordance with the detected pressure value.

2. The accelerator pedal device as set forth in claim 1, wherein the accelerator pedal comprises:
a pedal arm provided with a pedal portion, to which the pedaling force is applied, on a first end side;
an interlocking member engaged with a second end side of the pedal arm and rotating integrally with the pedal arm; and
a hysteresis generating mechanism comprising:
a first engagement part formed on the pedal arm; and
a second engagement part formed on the interlocking member so as to oppose to the first engagement part and engage with the first engagement part,
wherein the elastic member is engaged with either the pedal arm or the interlocking member, and
when the pedal arm rotates, the hysteresis generating mechanism divides a rotation force of the pedal arm into rotation force of the interlocking member and axial force in an axial direction substantially orthogonal to a rotation direction of the interlocking member.

3. The accelerator pedal device as set forth in claim 2, wherein the elastic member comprises a compression coil spring comprising:
a first end portion engaged with the end portion of the interlocking member; and
a second end portion engaged with a detection part side of the body.

4. The accelerator pedal device as set forth in claim 1, wherein the detection part comprises a pressure sensor being capable of converting the pressure value of the press force into an electric signal,
the pressure sensor is attached to an attachment hole formed on the body, and
a wiring connected to the pressure sensor and a connection terminal part connected to the wiring are formed integrally with the body.

5. The accelerator pedal device as set forth in claim 1, wherein the elastic member is arranged on substantially central part of the accelerator pedal in a width direction thereof, the width direction being substantially orthogonal to a rotational direction of the accelerator pedal.

6. The accelerator pedal device as set forth in claim 1, wherein the elastic member biases the accelerator pedal so as to return the accelerator pedal in an initial position where the pedaling force is not applied.

7. The accelerator pedal device as set forth in claim 1, wherein the first engagement part comprises a slant surface which is slant relative to a plane orthogonal to a rotational axis of the accelerator pedal,
the second engagement part comprising a slant surface which is slant relative to the plane orthogonal to the rotational axis of the accelerator pedal, and
the first engagement part contacts with the second engagement part on the respective slant surfaces.

8. The accelerator pedal device as set forth in claim 2, wherein at least one of protrusions is formed on either the first engagement part or the second engagement part, the protrusion comprising:
a slant surface which is slant relative to a plane orthogonal to a rotational axis of the accelerator pedal; and
an orthogonal surface which is orthogonal to the plane orthogonal to the rotational axis of the accelerator pedal;
wherein the slant surface and the orthogonal surface are arranged around the rotational axis of the accelerator pedal, and
at least one of grooves is formed on either the second engagement part or the first engagement part, of which shape corresponds to a shape of the protrusion so as to engage with the protrusion.

9. The accelerator pedal device as set forth in claim 2, wherein a friction surface is formed on either the pedal arm or the interlocking member,
a swollen portion is formed on the body so as to oppose to the friction surface, and
when the accelerator pedal does not rotate, a predetermined clearance is defined between the friction surface and the swollen portion and
when the accelerator pedal rotates, the friction surface slides against the swollen portion while the friction surface contacting with the swollen portion.

10. The accelerator pedal device as set forth in claim 2, wherein the elastic member is arranged on a side opposite to a side, in which the pedal portion is arranged, relative to a rotational axis of the accelerator pedal.

11. The accelerator pedal device as set forth in claim 1, wherein the elastic member applies reaction force against the pedaling force of the driver.

12. The accelerator pedal device as set forth in claim 1, wherein the elastic member is arranged so that a longitudinal axis of the elastic member is twisted relative to a rotational axis of the accelerator pedal, and
the elastic member elongates and contracts in the longitudinal axis thereof.

13. A vehicle comprising the accelerator pedal device as set forth in claim 1.

14. The accelerator pedal device as set forth in claim 2, wherein the pedaling force drives the hysteresis generating mechanism to generate the frictional resistance.
